(19) United States
(12) Patent Application Publication
(10) Pub. No.: US 2008/0267579 A1
(43) Pub. Date: Oct. 30, 2008

(54) Recording and reproducing apparatus with improved video editing function

(75) Inventors: Mari Yoshida, Chigasaki (JP); Nozomu Shimoda, Ninomiya (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/974,265

(22) Filed: Oct. 12, 2007

(30) Foreign Application Priority Data
Apr. 24, 2007 (JP) 2007-113649

(51) Int. Cl. G11B 27/00

(52) U.S. Cl. 386/52

(57) ABSTRACT

A recording and reproducing apparatus capable of solving a problem that, after a user edits video information recorded in a recording medium of a video camera, the user later cannot cancel the editing operation and cannot restore the edited video information to its initial information before edited. When the user edits video information recorded in a first recording medium; the video information deleted through the editing, video modification history information based on the editing, and data management information of the recording medium are recorded in a temporary storage area of a second recording medium. Thus, the user can cancel the editing of the video information and restore the information to its initial information before edited.

### INCORPORATION BY REFERENCE

The present application claims priority from Japanese application JP2007-113649 filed on Apr. 24, 2007, the content of which is hereby incorporated by reference into this application.

### BACKGROUND OF THE INVENTION

The technical field of the present invention is directed to a recording and reproducing apparatus and more particularly, to an improvement in the use convenience or handleablity of the recording and reproducing apparatus when video information is edited.

In a recording and reproducing apparatus, if video information erroneously modified by an user's erroneous operation can be restored to its initial information before modified, it is convenient to the user. When the video information is restored, a storage area for saving data necessary for the restoration becomes necessary. In particular, in order to cancel editing of video information conducted by a plurality of times or to cancel editing involving the deletion of the video information, a storage area having a sufficient capacity is indispensable.

One of prior arts in the technical field of the present application is disclosed, for example in JP-A-2004-145701. JP-A-2004-145701 discloses a recording and reproducing apparatus which records data management information about a hard disk (which will be referred to as the HDD (hard disk drive), hereinafter) in the HDD. In the known art, the aforementioned management information is used to restore music information when the music information ripped to the HDD is erroneously erased.

### SUMMARY OF THE INVENTION

In these years, a hybrid video camera having two recording media mounted therein is seen on the market. Even when video information recorded in the first recording medium is edited in the hybrid video camera, the editing cannot be canceled at a later time because the recording and reproducing apparatus cannot hold modification information about the video information caused by the editing. Further, when the video information is deleted by user's erroneous operation, the deleted video information cannot be restored. For this reason, the editing works of the video camera become inefficient and therefore user's use convenience becomes poor.

JP-A-2004-145701 discloses a data restoring method when music information ripped to the HDD is unintendedly deleted, but fails to disclose a technique for restoring the video information by canceling the modification of the video information caused by the user's erroneous operation in the hybrid video camera.

In accordance with an aspect of the present invention, the above problem can be solved by providing a recording and reproducing apparatus which has a function of recording backup video information, data management information, and video modification history information in a second recording medium each time that video information recorded in a first recording medium, and which enables a user to cancel editing of the video information conducted by the user at arbitrary timing and to restore the edited information to its initial information before edited.

With the above arrangement, even when the video information recorded in the first recording medium is edited by the user as an example, the video information can be restored to its initial information at a latter time. Even video information deleted by user's erroneous operation can also be restored.

Problems, means and effects other than the above will be clear as the embodiments which follow are explained.

Other objects, features and advantages of the invention will become apparent from the following description of the embodiments of the invention taken in conjunction with the accompanying drawings.

### BRIEF DESCRIPTION OF THE DRAWINGS

FIG. 1 shows a block diagram of an exemplary arrangement of a recording and reproducing apparatus;

FIG. 2 is an outside view of an HDD;

FIG. 3 is an outside view of a DVD;

FIG. 4 shows an example of video modification history information;

FIG. 5 shows an example of an internal structure of an edited history;

FIG. 6 shows an example of a backup flow of video information recorded in a DVD;

FIG. 7 shows an example of a processing flow when the DVD is loaded;

FIG. 8 shows an example of a processing flow when the video information recorded in the DVD is restored; and

FIG. 9 shows an example of a processing flow when the video information recorded in the DVD is subjected to UNDO operation.

### DESCRIPTION OF THE EMBODIMENTS

Detailed explanation will be made, as an example, in connection with a hybrid video camera as an embodiment of the present invention having a DVD as a first recording medium and an HDD as a second recording medium, with reference to the accompanying drawings. It is assumed that video information on one or more scenes are already recorded in the DVD.

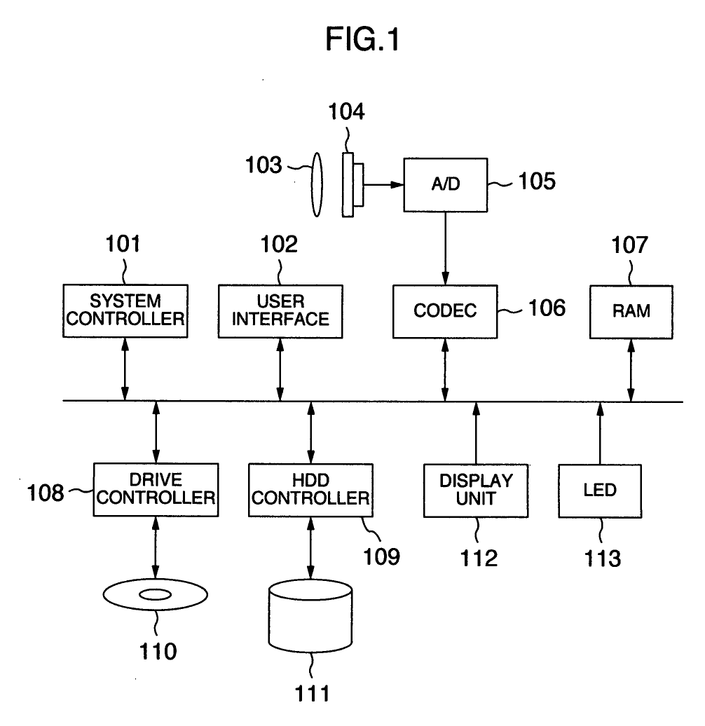

FIG. 1 is a block diagram of an embodiment when the present invention is embodied. Explanation will be made in connection with a hybrid video camera corresponding, as an example, to a DVD video camera having an HDD mounted therein. In this connection, the HDD may be replaced with a semiconductor memory or a disk medium. The DVD has a plurality of types such as DVD-R, DVD-RW, DVD-RAM, DVD+R and DVD+RW, but the type of the employed DVD is not specifically limited thereto. Of course, BD (Blu-ray Disc)-DVD or HD (High Definition)-DVD may be employed therefor. CD (Compact Disc) or MD (MiniDisc) may also be used therefor. In the present embodiment, it is assumed that DVD-RAM is used as the DVD.

A system controller 101, which has a CPU (Central Processing Unit) and a memory, functions to control the entire system. Input information from a user is acquired from a user interface 102 and is processed by the system controller 101. Light obtained through a lens 103 is converted to an electric signal by a CCD (Charge Coupled Diode) 104. An A/D converter 105 converts the analog electric signal input from the CCD 104 into a digital signal, and passes the converted digital signal to a CODEC (COmpresion/DECompression) 106. A stream encoded and generated by the CODEC 106 is stored in a RAM (Random Access Memory) 107. A drive controller 108 and an HDD controller 109 control accesses to a DVD 110 and to an HDD 111 respectively. The stream information stored in the RAM 107 is recorded in the DVD 110 and in the HDD 111 through the drive controller 108 and through the HDD controller 109 respectively. A display unit 112 is a display device for displaying a video thereon. Although the display unit is explained as a liquid crystal display (LCD), the display unit may be an organic EL display or the like. An LED 113 is turned ON when a power is turned ON, when charging is carried out, or when an access is made to the recording medium, to indicate the operational state of the recording and reproducing apparatus. Though not illustrated, it is assumed that the recording and reproducing apparatus has functions including all the functions of a general video camera such as a battery function.

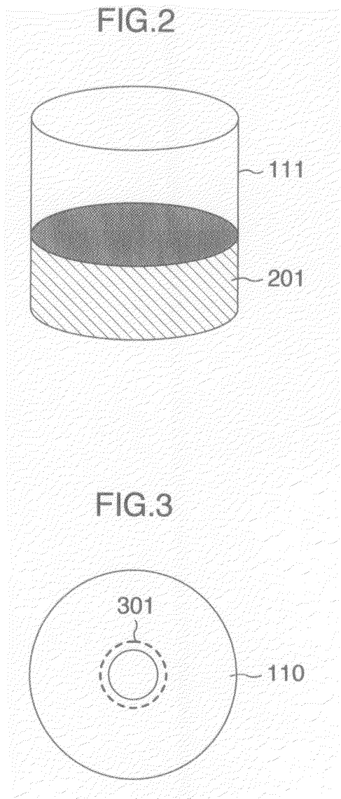

FIG. 2 is a conceptional view of an HDD, wherein reference numeral 201 denotes a temporary storage area for recording backup video information, DVD data management information, and video modification history information about an DVD 110. The backup video information indicates video information deleted by editing video information recorded in the DVD. The DVD data management information indicates data management information on the entire DVD in which a recorded date, a data size, etc. about video information recorded in the DVD are written. It is assumed in the present embodiment that the DVD data management information is generated from an IFO file having management information about the video information recorded in the DVD. Recorded in the DVD data management information are all information included in the IFO file, a DVD identification ID and so on. It is also assumed that a history of how video information is edited for each editing of the video information recorded in the DVD is written in the video modification history information. The temporary storage area 201 is reserved in an area of the HDD 111 different from another area for recording photographed video information. In a normal operation, the temporary storage area is transparent to the user.

FIG. 3 is an outside view of a DVD, wherein reference numeral 301 denotes a data recording area called BCA (Burst Cutting Area). Information unique to the disc is recorded in the BCA 301 by marking a scratch inside of the data area of the DVD 110 with use of a special laser beam. The information on the BCA can be read out based on a reflection factor difference with use of a conventional light pickup device. In this case, identification ID information unique to the DVD is recorded in the BCA. As another identification ID recording means, part of a DVD recording area may be used to record therein a serial number set by a video camera as the DVD identification ID, or the identification ID may be recorded as a file in the DVD. In the latter case, the loaded DVD can be linked to backup data by reading out the file. In the present embodiment, based on the DVD identification ID of the video camera, the DVD 110 is linked to the backup video information recorded in the temporary storage area 201 of the HDD 111, and also to the data management information and video modification history information of the DVD. As a result, data recorded in the temporary storage area of the HDD can be linked to data recorded in the loaded DVD, thus avoiding erroneous operation when different DVDs are loaded.

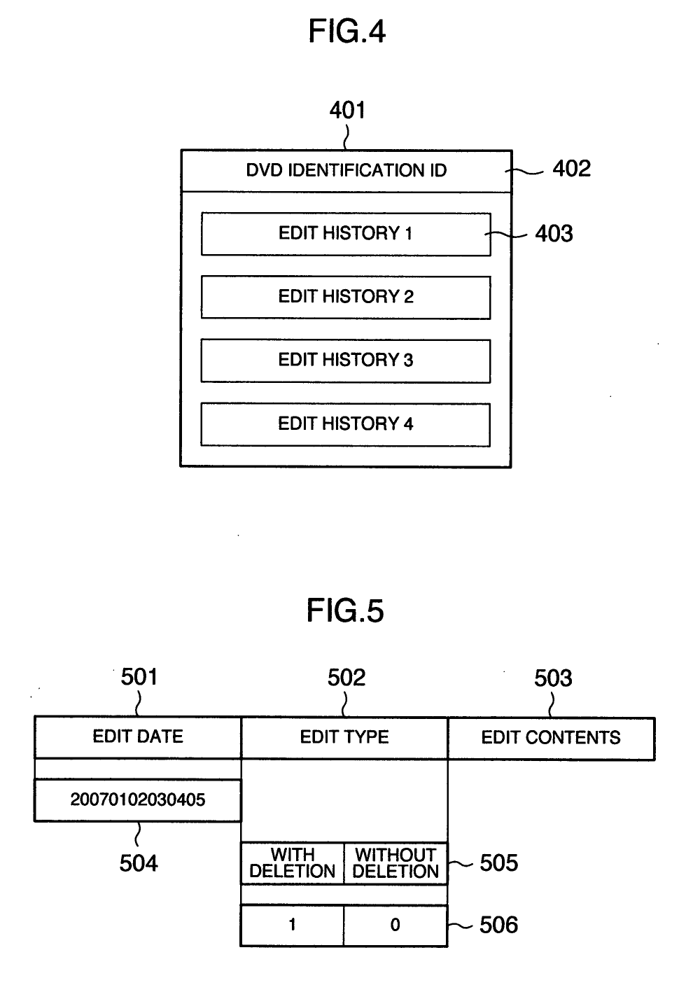

By referring to FIGS. 4 and 5, explanation will be made as to video modification history information required when edited video information is restored to its initial information before edited. FIG. 4 shows an example of the video modification history information which is to be recorded in the temporary storage area 201 of a second recording medium. In this example, reference numeral 401 denotes video modification history information about video information recorded in a DVD. A DVD identification ID 402 denotes an DVD identification ID corresponding to the history information in an one-to-one relation. An edit history 403 is edit data record information which is recorded for each editing of video information recorded in the DVD. Each time video information recorded in the DVD is edited, the edit history 403 is added to the video modification history information 401. The video camera can be improved in use convenience when the user can set an upper limit of the number of histories added to the video modification history information or can set the quantity of data. By virtue of the user settability, if the user wants to give importance to the amount of data, then the user can set the upper limit at a large value. Of course, the upper limit of the quantity of backup data settable by the user cannot be set to be larger than the upper limit of capacity of the temporary storage area.

FIG. 5 shows an example of details of the edit history 403. In the edit history 403, an edit date/time 501, an edit type 502, and edit data 503 are included. Reference numeral 504 shows an example of the edit date/time 501 expressed by a number having 14 digits including time information on dominical year, date and second. In this connection, a serial number for an edited history may be created and may be used in place of the edit date/time. The edit type 502 is expressed by 1-bit data which determines whether or not editing involves deletion of video information. As shown by reference numerals 505 and 506, the edit type is set at “1” when the editing involves deletion and otherwise, the edit type is set at “0”. Information on the video information subjected to the editing is recorded in the edit data 503. When the editing involves deletion of the video information, an area for storing the amount of deleted data may be reserved.

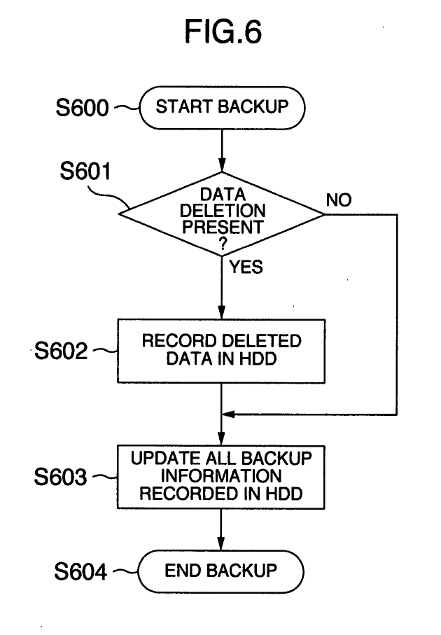

By referring to FIG. 6, explanation will be made as to the backup operation of the hybrid video camera of the present embodiment when modification information about video information recorded in the DVD is recorded in the temporary storage area of the HDD for each editing of the video information. FIG. 6 shows a flow chart of a backup flow after the video information recorded in the DVD is edited by the user through the user interface 102. In the present embodiment, it is assumed that the user can edit the video information recorded in the DVD using a menu. In a step S600, the program accepts an edit command of the video information from the user. In a next step S601, the program determines whether or not user's editing involves deletion of the video information recorded in the DVD. For example, when the user conducts only dividing operation of a scene recorded in the DVD, the program determines that the editing involves no deletion of the video information, and proceeds to a step S603. In the step S603, the same ID information as an identification ID information read out from the loaded DVD is added to DVD data management information modified after the editing, and then recorded in the temporary storage area of the HDD. An edit history including the edit data is added to the video modification history information recorded in the temporary storage area, and then recorded. When the program determines in the step S601 that the editing involves deletion of the video information, the video information deleted in the step S602 is linked to the edit history in an one to one relation, and then recorded in the temporary storage area of the HDD.

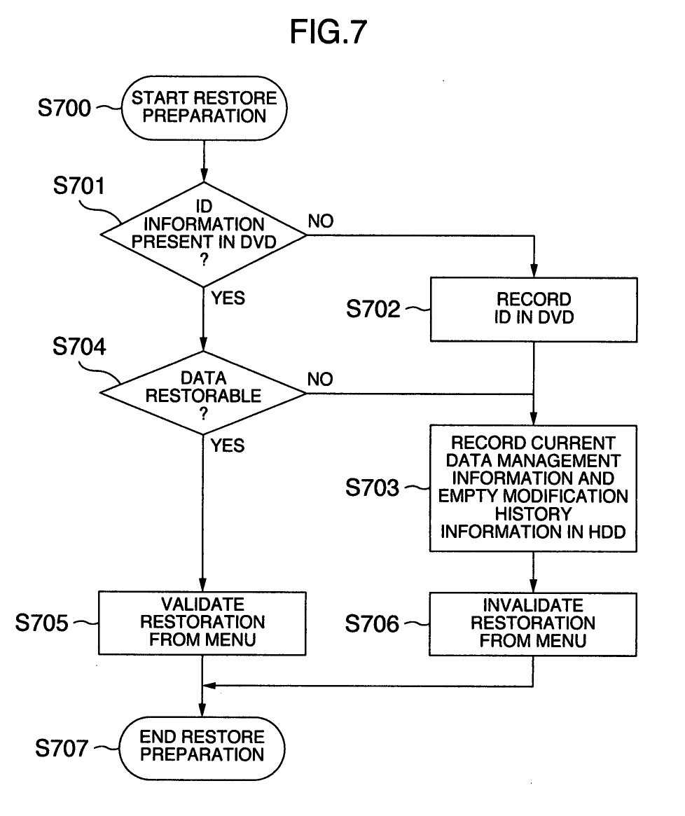

By referring to FIG. 7, explanation will be made in the hybrid video camera of the present embodiment as to preparing the video restoring operation of canceling the conducted editing of video information recorded in the DVD and restoring the video information to its initial information before edited. FIG. 7 shows an example of a flow chart of the preparing operation for the video-information restoration when the DVD is loaded. In this connection, the DVD may be a brand-new DVD or a DVD having information already recorded therein. When the program recognizes the fact that the DVD is loaded in a step S700, the program determines in a step S701 whether or not a file having DVD identification ID information recorded therein is present in the loaded DVD. When the DVD is a brand-new DVD or a DVD having information already recorded therein by another video camera, such a file having DVD identification ID information recorded therein is not present. In the absence of such a file having the identification ID recorded in the DVD, the program records the identification ID information in the DVD as a file in a step S702, adds the DVD identification ID information to the DVD data management information and the added information in the temporary storage area of the HDD in a step S703. Empty video modification history information having the DVD identification ID information added thereto but the edit histories thereof being empty, is also created and recorded in the temporary storage area of the HDD. Thereafter, in a step S706, the user sets the video information from a menu in such a manner that the video information cannot be restored, terminating the restoration preparing operation. When the program determines that the DVD having the identification ID information recorded therein is loaded in the step S701, the program determines in a step S704 whether or not DVD data management information corresponding to an identification ID recorded in the DVD is recorded in the temporary storage area of the HDD. In the absence of the corresponding data management information, the program performs the operation of the step S703. The operation of the subsequent step S706 is as follows. When the program determines in the step S704 the presence of the corresponding data management information, the user sets in a step S705 the camera from a menu in such a manner that the user can restore the video information, thus terminating the restoration preparing operation. If the user manually sets the camera in such a manner that backup video information in the temporary storage area of the HDD can be written in the DVD, then the use convenience of the camera is enhanced. Upon the rewriting of the backup video information, if the user can set the camera in such a manner that the user can arbitrarily determine a position, at which the backup video information is rewritten or can determine a position to be written using a shot time included in the video modification history information, then once-deleted video information can be restored even in a DVD having a different identification ID, with an improved use convenience. When the camera is set so that the user can determine deletion or non-deletion of the backup video information written in the DVD from the temporary storage area of the HDD, the use convenient can be further increased for the user who wants to delete unnecessary data from the temporary storage area. When the DVD identification ID information is recorded in the BCA of the DVD, the determining operation of the step S701 becomes unnecessary. In this case, after the program recognizes the loaded DVD in the step S700, the program goes directly to the step S704 not via the step S701 to execute the operation of the step S704.

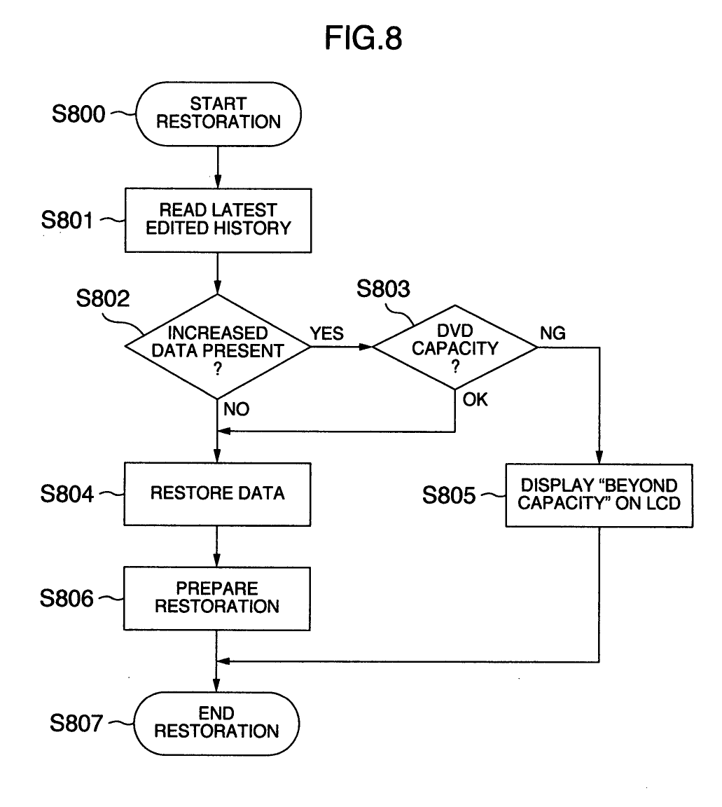

Explanation will be made as to the operation of restoring DVD video information by referring to FIG. 8. The drawing shows an exemplary flow chart after the user executes restoring operation of the video information until the restoring operation is terminated. When the program accepts a restore command from the user in a step S800, the program reads out video modification history information from the temporary storage area of the HDD in a step S801. In a step S802, the program confirms the edit data of the latest edit history included in the video modification history information. When the edit type 506 has a value of “0”, the program determines no possibility that restoration of the video information causes the amount of data recorded in the DVD to exceed the capacity of the DVD, and executes restoring operation of the video information in a step S804. In the then restoration of the video information, the DVD data management information recorded in the temporary storage area of the HDD and the latest edit history in the video modification history information are used, so that the editing last conducted by the user is canceled and the initial video information before edited is restored. When the edit type 506 included in the latest edited history has a value of “1” in the step S802, the program determines the presence of a possibility that the amount of data of backup video information to be scheduled to be restored exceeds the capacity available in the loaded DVD. Thus, in a step S803, the program compares the capacity available in the DVD with the restoration-scheduled data amount. When the program determines that the amount of data of the restoration-scheduled backup video information fails to exceed the available DVD capacity, the program restores the video information in a step S804. When the program determines that the data amount exceeds the available capacity in the step S803, the program causes the LCD 112 to display the data amount exceeding the DVD available capacity in a step S805. When the program restores the data in the step S804, the program performs the restoration preparing operation mentioned in FIG. 7, and terminates its restoring operation in a step S807. When the amount of data recorded in the temporary storage area of the HDD reaches the upper limit of the number of edited history recorded in the temporary storage area, the program deletes old-dated data in the temporary storage area. At this time, as an example, before the old-dated data is deleted, a message may be displayed on the LCD. Or the user may set whether to delete the old-dated data. When the user deletes the video information, a priority may be previously applied to the data to be deleted, so that, when the amount of data recorded in the temporary storage area of the HDD reaches the upper limit of the temporary storage area, the program can delete old data in an increasing order of the priorities.

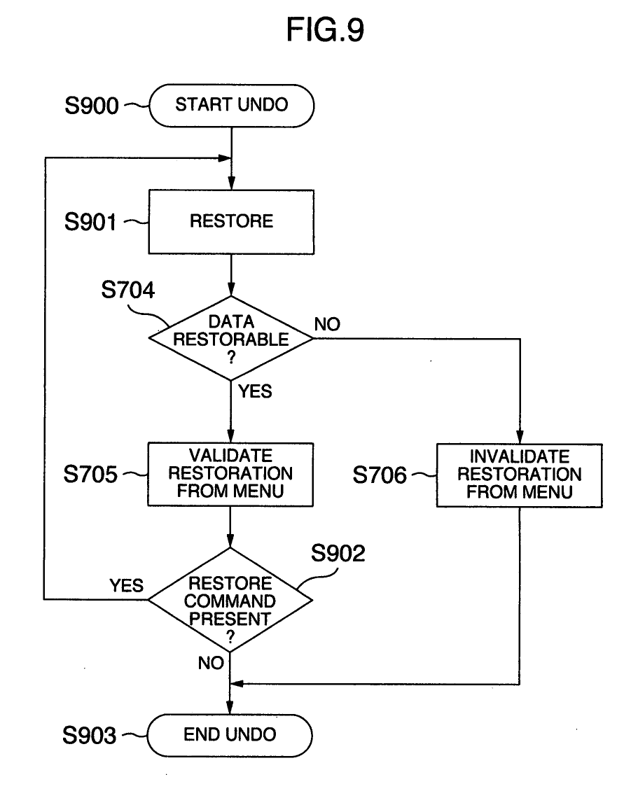

By referring to FIG. 9, explanation will be made as to continuous restoring operation of DVD video information, so-called UNDO operation. FIG. 9 shows an example of a flow chart when a user performs UNDO operation. In a step S901, the program executes restoring operation explained in FIG. 8. Thereafter, in the steps S704 to S706, the program determines whether to continue the restoring operation. The then details of the processing steps are as already explained above. In a step S902, the program subsequently determines whether or not a restore command from the user was executed. When the user wants to further restore the state of the video information, the user executes the restore command and the program returns to the step S901. Since the video information was restored to the desired initial information, the user executes no restore operation, and the program proceeds to the step S903 to terminate its UNDO operation. The DVD data management information and the video modification history information in the HDD used for the UNDO operation of the video information are necessarily deleted from the temporary storage area of the HDD after completion of the UNDO operation. However, when the program is designed so that the user can set whether to delete the backup video information from a menu, the use convenience of the camera is enhanced. At this time, when the user sets the camera so as to delete the backup video information, the capacity of the temporary storage area can be saved. When the user sets the camera so as not to delete the backup video information, on the other hand, the user can again restore the same video information later. When the upper limit of the amount of data recorded in the temporary storage area of the HDD is settable by the user; the user, who wants to have an increased capacity of the video storage area, is only required to set the upper limit at a smaller value with an enhanced use convenience. The frequency of UNDO operation is proportional to the amount of backup information recorded in the temporary storage area of the HDD. Thus, when the sets the upper limit of the capacity of the temporary storage area at a large value, the UNDO frequency can also be increased. In this connection, when such a menu is provided that all edited histories recorded in the temporary storage area of the HDD can be restored in a single procedure, such troublesome works that the user performs UNDO operation many times can be eliminated with an enhanced use convenience.

According to the foregoing embodiment explained above, the video camera can have a function of restoring video information edited by a user to its initial video information later at desired timing.

Although the present embodiment is assumed to restore the video information recorded in the DVD, the embodiment can similarly restore the video information recorded in the HDD.

It should be further understood by those skilled in the art that although the foregoing description has been made on embodiments of the invention, the invention is not limited thereto and various changes and modifications may be made without departing from the spirit of the invention and the scope of the appended claims.

1. A recording and reproducing apparatus comprising:
a plurality of recording media including first and second recording media;
video information input means having an imaging element;
recording means for recording video information from said video information input means onto the recording media;
reproducing means for reproducing the video information recorded in said recording media;
a display unit for displaying a video thereon;
duplicating means for copying or moving the video information from the first recording medium to the second recording medium;
a temporary storage area reserved in the second recording medium;
editing means for editing the video information recorded in the first recording medium;
first storage means for storing the video information recorded in the first recording medium but deleted therefrom in the second recording medium as backup video information; and
second storage means for storing data management information about the video information and video modification history information based on editing of the video information recorded in the first recording medium into the second recording medium.

2. A recording and reproducing apparatus according to claim 1, comprising rewriting means for rewriting the backup video information recorded in a temporary storage area of the second recording medium into the first recording medium as its initial video information with use of the backup video information, the data management information and the video modification history information in the first recording medium, and wherein the video information is rewritten in the first recording medium by said rewriting means.

3. A recording and reproducing apparatus according to claim 1, comprising restoring means for restoring the video information recorded in the first recording medium with use of the backup video information, the data management information, and the video modification history information of the first recording medium, recorded in the second recording medium, and wherein video information edited by a user is restored to the first recording medium by said restoring means.

4. A recording and reproducing apparatus according to claim 1, comprising deleting means for deleting the data management information and the video modification history information recorded in the temporary storage area of the second recording medium from the second recording medium after the video information of the first recording medium is successfully restored, and wherein the data management information and the video modification history information in said temporary storage area used for restoration are deleted by said deleting means after the restoration of the video information is successfully restored.

5. A recording and reproducing apparatus according to claim 1, wherein, when the backup video information recorded in the second recording medium is restored in the first recording medium, a position for the video information to be restored is determined based on a time included in the video modification history information recorded in the second recording medium.

6. A recording and reproducing apparatus according to claim 1, comprising setting means for a user to set a position when the backup video information of the first recording medium recorded in the second recording medium is restored in the first recording medium with use of the data management information, and wherein the user can set the position when the backup video information is restored in the first recording medium with use of the data management information.

7. A recording and reproducing apparatus according to claim 3, comprising setting means for enabling the user to set whether to delete the backup video information recorded in the second recording medium after the video information of the first recording medium is successfully restored, and wherein the user can set whether to delete the backup video information of the second recording medium by said setting means after the video information is successfully restored.

8. A recording and reproducing apparatus according to claim 1, comprising setting means for the user to set the apparatus in such a manner that old data recorded in said temporary storage area is deleted in an older order of date of the old data when the amount of data recorded in the temporary storage area of the second recording medium reaches a predetermined level, and wherein the user can set how to delete the data in said temporary storage area by said setting means.

9. A recording and reproducing apparatus according to claim 1, comprising recording means for recording an ID unique to the first recording medium in a DVD (Digital Versatile Disc) as the first recording medium, and wherein the ID unique to the DVD is recorded by said recording means.
